(19) United States
(12) Patent Application Publication
(10) Pub. No.: US 2002/0185577 A1
(43) Pub. Date: Dec. 12, 2002

(54) Hanging device for support structures

(76) Inventor: Michael David Sapp, Bloomington, IL (US)

Correspondence Address: MERCHANT & GOULD PC, P.O. BOX 2903, MINNEAPOLIS, MN, 55402-0903, US

(21) Appl. No.: 10/153,362

(22) Filed: May 21, 2002

Related U.S. Application Data
(60) Provisional application No. 60/293,777, filed on May 25, 2001.

(51) Int. Cl. E06C 7/14

(52) U.S. Cl. 248/210; 206/373; 182/129

(57) ABSTRACT

A hanging device for support structures is provided. The hanging device includes a hanging bar and engaging brackets. The engaging brackets are coupled to the hanging bar. The engaging brackets couple the hanging device to the support structure. A method for hanging a tool belt from a stepladder is also provided.

### FIELD OF INVENTION

The present invention relates to a device and method for hanging items. More particularly, the device includes a hanging bar for suspending items and engaging brackets that can be coupled to support structures, such as stepladders.

### BACKGROUND OF THE INVENTION

Persons working on construction and other improvement projects often need a number of tools to complete the project. The use of the tools is often accompanied with the worker climbing up and down and moving ladders, such as stepladders. Additionally, the worker may use a tool belt to hold the tools.

Tools are often placed on the steps or tops of stepladders or are placed on the ground. Placing tools on the stepladder requires that the ladder be moved carefully to a new location so the tools do not fall from the ladder onto the worker. Otherwise the worker has to remove the tools from or secure the individual tools before moving the ladder. Placing tools on the ground requires a worker to bend over and/or climb down a ladder to pick up a different tool.

If the worker has a tool belt, it can become difficult to climb up and down the ladder because of the weight and size of the tools hanging from the belt. The tools may catch on a step of the ladder as the worker climbs the ladder. Also, the worker can have difficulty in reaching the tools from the belt as he works because he may have to lean away from the ladder to grab a tool, which may cause him to loose his balance.

In other systems, a fixed tool holding system is used with a stepladder. Such systems do not allow the worker to use alternative styles or types of tool belts, to remove a tool belt from his waist and couple it onto the stepladder, or to hang larger items from the stepladder.

As a result of shortcomings of prior systems, time and/or money can be wasted and the worker can potentially be injured when using tools in connection with ladder usage.

### SUMMARY OF THE INVENTION

In general terms, the present invention relates to devices for supporting the tools of a worker. More particularly, the present invention relates to a device that allows a tool belt or other item to be removably hung in a convenient and safe location for a worker.

In one aspect, the invention relates to a method for hanging a tool belt, including placing a removable item onto a hanging device, wherein the hanging device comprises a hanging bar and engaging brackets; and placing the hanging device onto side rails of a stepladder, wherein the engaging brackets couple the hanging device to the side rails.

In one aspect, the invention relates to a hanging device for support structures, including a hanging bar and engaging brackets. The hanging bar removably engages at least one item. The engaging brackets are coupled to the hanging bar. The engaging brackets couple the hanging device to an angled support structure.

In another aspect, the invention relates to a hanging device for support structures, including a hanging bar and engaging brackets. The hanging bar includes a first portion adjustably coupled to a second portion. The hanging bar removably engages at least one item. The engaging brackets are coupled to the hanging bar. The engaging brackets couple the hanging device to an angled support structure.

In another aspect, the invention relates to a supporting device, including hanging bar, engaging brackets coupled to the hanging bar, and an angled support structure. The engaging brackets are coupled to the angled support structure and at least one item is removably suspended from the hanging bar.

In yet another aspect, the invention relates to a supporting device, including a support structure and a hanging device. The support structure comprises a support bar coupled to a support rod. The support bar comprises angled sidebars. The hanging device is coupled to the angled sidebars.

In yet another aspect, the invention relates to hanging device for support structures including a hanging bar and engaging brackets. The hanging bar removably engages at least one item. An upper edge of the hanging bar defines a notch. The engaging brackets are coupled to the hanging bar. The engaging brackets couple the hanging device to an angled support structure.

The above summary of the present invention is not intended to describe each disclosed embodiment or every implementation of the present invention. The Figures and the detailed description that follow more particularly exemplify embodiments of the invention. While certain embodiment of the invention will be illustrated in describing embodiments of the invention, the invention is not limited to use in such embodiments.

### BRIEF DESCRIPTION OF THE DRAWINGS

FIG. 1 is a bottom schematic view of one embodiment of a hanging device for support structures;

FIG. 2 is a front schematic view of one embodiment of the hanging device of FIG. 1 coupled to the side rails of a stepladder and a tool belt suspended from the hanging device;

FIG. 3 is a top schematic of the hanging device engaging the side rails of a stepladder and a tool belt suspended from the hanging device of FIG. 2;

FIG. 4 is a bottom schematic view of a second embodiment of a hanging device for support structures;

FIG. 5 is a front and top schematic perspective view of a third embodiment of a hanging device for support structures;

FIG. 6 is a front and top schematic perspective view of a fourth embodiment of a hanging device for support structures;

FIG. 7 is a front schematic view of one embodiment of a supporting device;

FIG. 8 is a back schematic view of the supporting device of FIG. 5; and

FIG. 9 is a front top schematic perspective view of a fifth embodiment of a hanging device for support structures.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to over all modifications, equivalents, and alternatives falling within the spirit and scope of the invention.

### DETAILED DESCRIPTION OF THE PREFERRED EMBODIMENTS

The above specification, examples and data provide a complete description of the manufacture and use of the composition of the invention. Since many embodiments of the invention can be made without departing from the spirit and scope of the invention, the invention resides in the claims hereinafter appended.

The present disclosure generally relates to a device that can be used to hang items from support structures. More particularly, the present disclosure relates to a hanging device that allows for the removal and interchange of tool belts or other items for convenient and safe hanging. While the present invention is not so limited, an appreciation of various aspects of the invention will be gained through a discussion of the examples provided below.

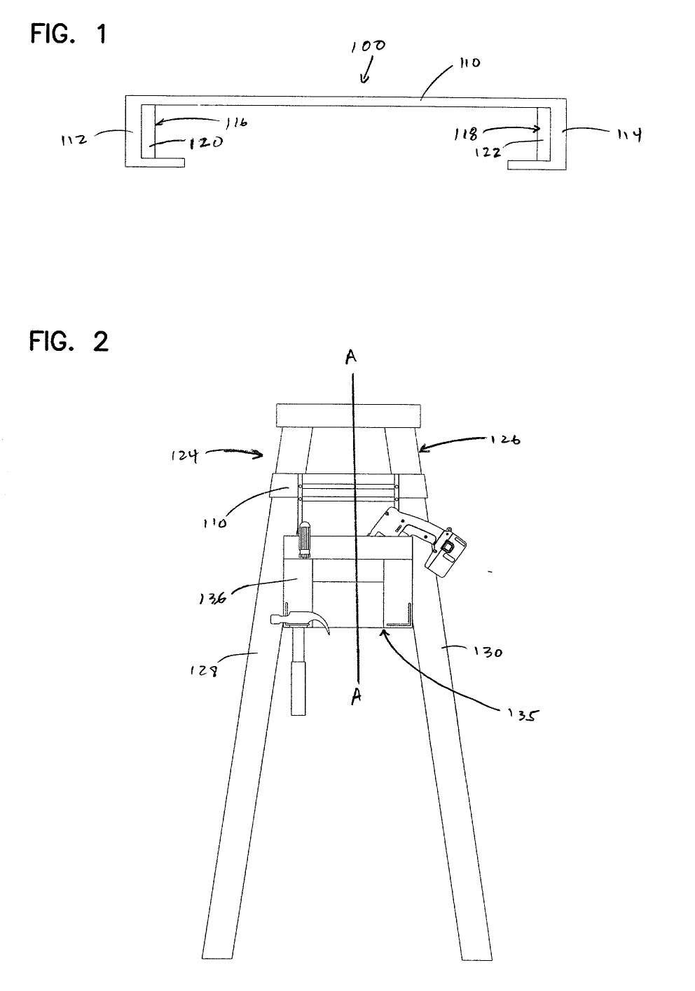

Referring to FIG. 1, a schematic bottom view of one embodiment of a hanging device 100 is shown. The hanging device 100 can be constructed of metal, plastic, ceramic or any other suitable material. Hanging device 100, that is constructed of metal, for example, can be coated with plastic or painted.

The hanging device 100 has a hanging bar 110 and engaging brackets 112 and 114. The hanging bar 100 is shown with a partial rectangular shape. Alternatively, the hanging bar can be any other shape, such as, for example, square, round, trapezoidal, or oval.

The engaging brackets 112 and 114 can be formed into a single unit with the hanging bar 110 as shown in FIG. 1. As a single unit, the hanging device 100 can be constructed, for example, from a single piece of metal that is bent to form the engaging brackets 112 and 114. Alternatively, the engaging brackets can be separate units from the hanging bar that are coupled to the hanging bar using attachment means known. For example, the engaging brackets can be attached with a nut and bolt, welded onto, or pivotally coupled to ends of the hanging bar.

The brackets 112 and 114 include inner surfaces 116 and 118. Preferably, the brackets 112 and 114 have a C-shape as shown in FIG. 1. Alternatively, any shape can be used for the engaging brackets, such as, for example, an L-shape. As shown in FIG. 2, the engaging brackets 112 and 114 include sloped portions 120 and 122. Alternatively, the engaging brackets can be constructed without sloped portions.

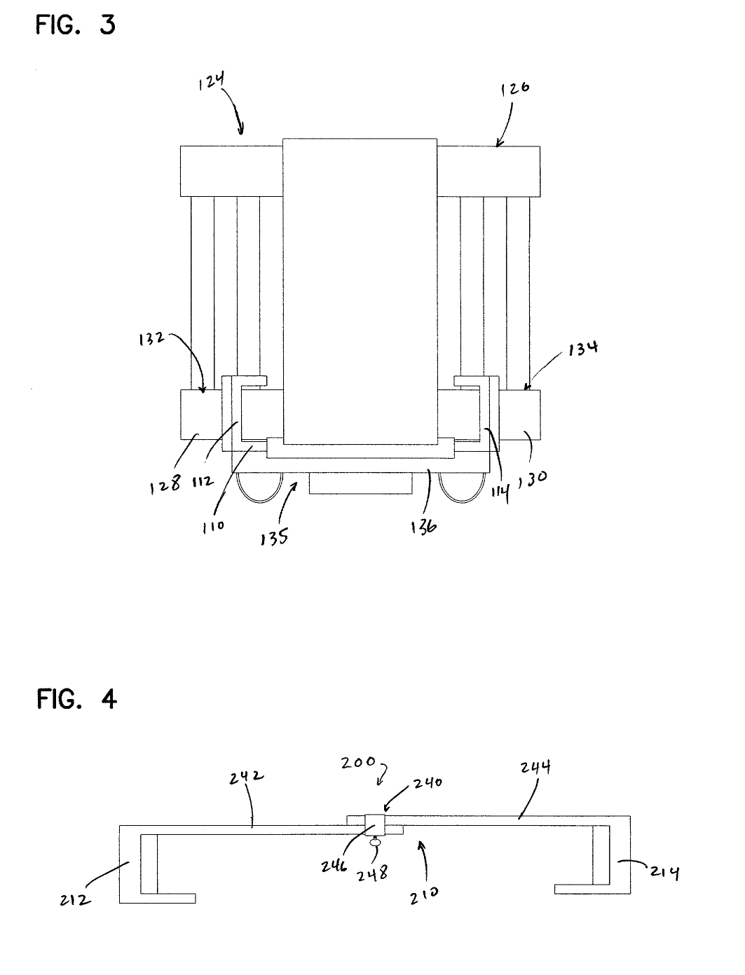

Referring to FIGS. 2 and 3, the hanging device 100 can be placed on support structure 124, such as, for example, a stepladder 126. The stepladder 126 includes side rails 128 and 130. The side rails 128 and 130 include top surfaces 132 and 134.

When the stepladder is in an open position, as shown in FIG. 2, the hanging bar 100 is placed over the side rails 128 and 130 and the engaging brackets 112 and 114 engage the side rails 128 and 130. When the hanging device 100 is in a desired position, the inner surfaces 116 and 118 of the engaging brackets 112 and 114 are in frictional contact with the top surfaces 132 and 134 of the side rails 128 and 130.

The sloped portions 116 and 118 of the hanging device 110 can be set at any angle relative to vertical axis A-A (FIG. 2). Preferably, the angle of the sloped portions 116 and 118 is set to match the angle of the rails 128 and 130 relative to the vertical axis A-A. For example, as shown in FIG. 2, after the stepladder is placed in its open position, each of the side rails 128 and 130 form an angle relative to the vertical axis A-A. The angle of the sloped portions 120 and 122 match that of the rails 128 and 130 to secure the hanging device 100. Alternatively, engaging brackets that are pivotally coupled to the hanging bar can be used to provide engagement at various angles found in different support structures.

An item 135, such as a tool belt, can be hung from the hanging device 100. For example, as shown in FIG. 3, the hanging device 100 can be placed through an opening of a tool belt 136 that can include pouches and devices for holding tools, such as hammers, screw drivers, tape measures, cordless or non-cordless power tools, or any other item. The hanging device 110 and tool belt 136 combination can then be placed onto the support structure 124, as shown in FIG. 2 and described above.

The tool belt 136 can alternatively include straps that can be tied to the hanging bar or modified to include button snaps that can be easily opened or closed for the removal or placement of the tool belt from or onto the hanging device 100. Alternatively, other belt types can be hung from the hanging device or a hook can be placed over the hanging bar to suspend items, such as a bucket or paint can, from the hanging device.

The hanging device 100 can be constructed to any desired width. Width, as defined herein, is measured as the distance between midpoints of the engaging brackets 112 and 114. Depending on the width of the support structure, such as the stepladder 126 shown in FIG. 2, the hanging device 100 can be constructed accordingly to provide a desired height above a floor, ground, or other surface for the worker. For example, the greater the width of the hanging device 100, shown in FIG. 2, the closer to the floor, ground, or other surface, the tool belt will be located.

Referring to FIG. 4, a second embodiment of a hanging device 200 is shown. The hanging device 200 includes a hanging bar 210 and engaging brackets 212 and 214. The hanging bar 210 is separated into a first portion 242 and a second portion 244. The hanging device 200 includes a securing device 240 that adjustably couples the first portion 242 to the second portion 244. The width of the hanging device 200 can be adjusted based upon the size of the support structure or the desired height level for the hanging device 200. Any suitable securing device 240 can be used to couple the first portion 242 and second portion 244. For example, as shown in FIG. 4, a ring 246 can be placed around the first portion 242 and second portion 244. The worker can adjust the relative positions of the first portion 242 and second portion 244 to a desired hanging device 200 width. A setscrew 248 can be screwed into a threaded setscrew hole defined by the ring 246 to couple the first portion 242 and the second portion 244 and temporarily fix the width of the hanging device 200.

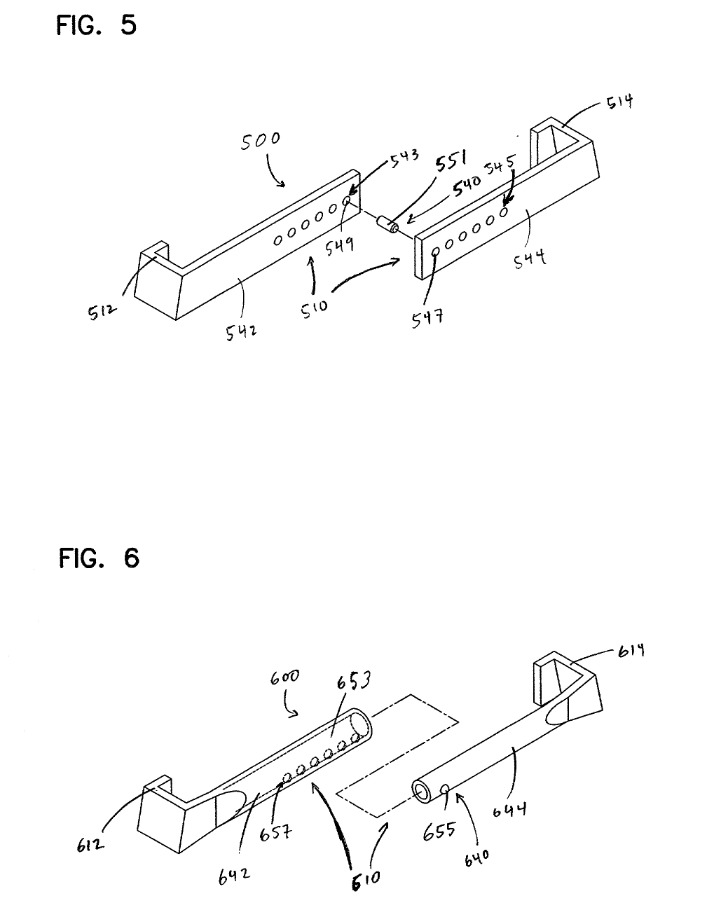

Referring to FIG. 5, a third embodiment of a hanging device 500 is shown. The hanging device 500 includes a hanging bar 510 and engaging brackets 512 and 514. The hanging bar 510 is separated into a first portion 542 and a second portion 544. The first portion 542 and the second portion 544 can each define a series of holes 543 and 545. The positions of the first portion 542 and second portion 544 can be adjusted relative to each other until at least one hole 547 on the first portion matches at least one hole 549 on the second portion. A securing device 540, such as first pin 551, can be inserted through the holes to temporarily secure the first and second portions. Optionally, a second hole on the first portion can match a second hole on the second portion. A second pin can be inserted through the second holes to temporarily secure the first and second portions and eliminate pivoting action of the first and second portions at the first pin.

Referring to FIG. 6, a fourth embodiment of a hanging device 600 is shown. The hanging device 600 includes a hanging bar 610 and engaging brackets 612 and 614. The hanging bar 610 includes a first portion 642 and a second portion 644. The first portion 642 and the second portion 644 can have a telescopic arrangement, as shown in FIG. 6. For example, the first portion 642 can define a cavity 653 into which the second portion 644 is inserted. The relative positions of the first portion and the second portion can be adjusted to a desired hanging device 600 width and held in place with any suitable temporary securing device 640, such as, for example, a setscrew or spring activated button. The securing device 640, shown in FIG. 6, includes a spring-activated button 655 that engages at least one hole of a plurality of holes 657 defined by the first portion 642 and temporarily fixes the width of the hanging device 600.

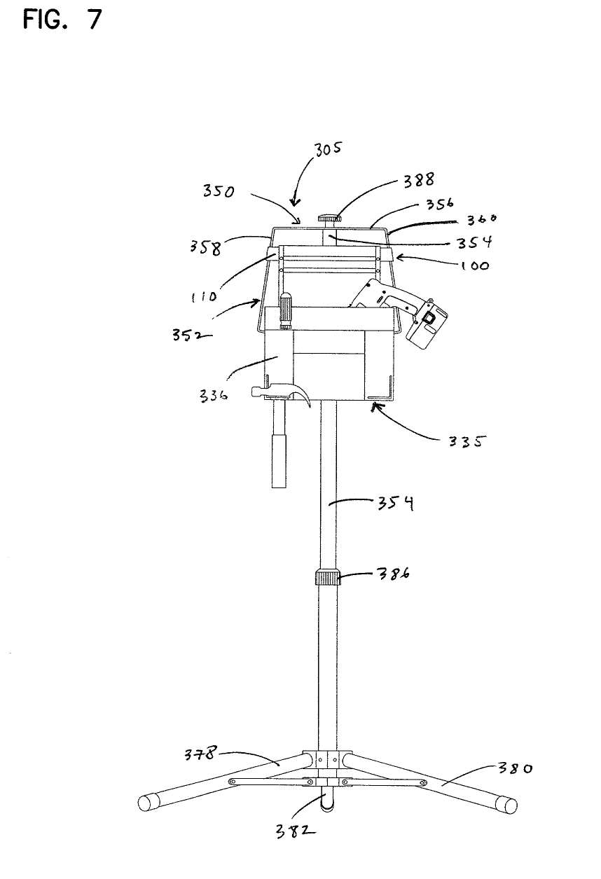

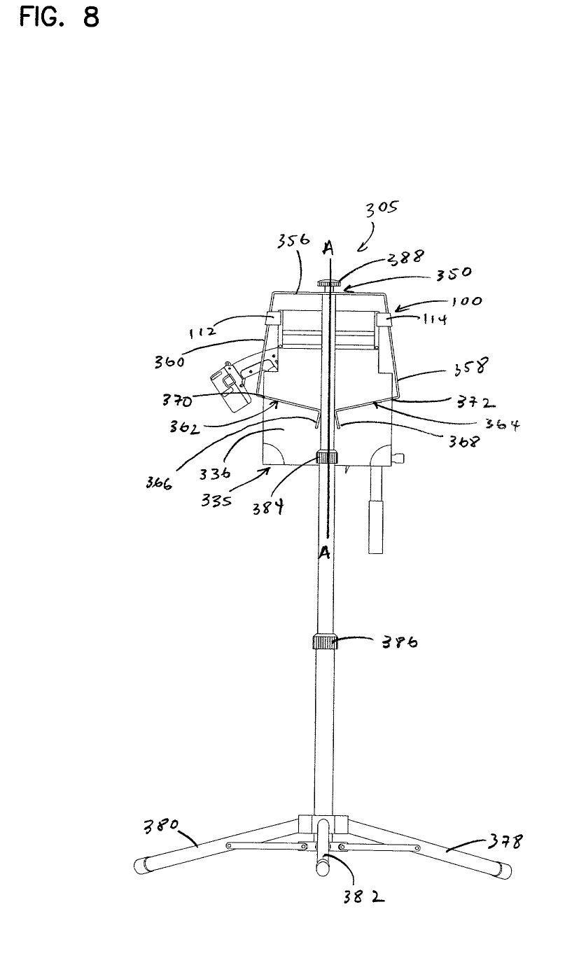

Referring to FIGS. 7 and 8, an embodiment of a supporting device 305 is shown. The supporting device 305 includes hanging device 100 and a support structure 350. Hanging device 100 includes hanging bar 110 and engagement brackets 112 and 114, as described for the embodiments disclosed above. An item 335, such as a tool belt 336, can be suspended from the hanging device 100. The supporting device 305 can be used to suspend the item 135 next to a ladder or in connection with any other project. The support structure 350 includes a support bar 352 and a support rod 354.

The support bar 352 includes a top portion 356, side portions 358 and 360, and two lower portions 362 and 364. The two lower portions 362 and 364 include two substantially vertical bars 366 and 368 and two substantially horizontal bars 370 and 372. The side portions 358 and 360 are angled relative to a vertical axis A-A (FIG. 8) so the inner surfaces 116 and 118 of engaging brackets 112 and 114 engage top surfaces 374 and 376 of the side portions 358 and 360 following placement of hanging device 100 over the support structure 350. When hanging device 100 reaches a desired position, the

substantially vertical portions 366 and 368 can engage the support rod 354, as shown in FIG. 6.

The support rod 354 can include legs 378, 380, and 382 that form a tripod structure, as shown in FIGS. 5 and 6. A tripod support rod, such as the one shown in FIGS. 5 and 6, can be purchased from Regent Lighting Corporation located in Burlington, N.C. Alternatively, the support rod can include a pointed end with or without the tripod structure that can be driven into the ground when working on outdoor projects.

The support rod 354 can be adjustable in height through adjustment mechanisms 384 and 386. Alternatively, additional adjustment mechanisms, a single adjustment mechanism, or no adjustment mechanism can be used. The worker can alter the height of the rod so the hanging bar is properly positioned for the work being conducted.

The support bar 352 can be coupled to the support rod 354 by any coupling technique known in the art. For example, the support rod 354 can define a hole for screwing a knob 388 into the support rod 354. The support bar 352 can define a second hole through which a screw is placed and then screwed into the hole defined by the support rod 354.

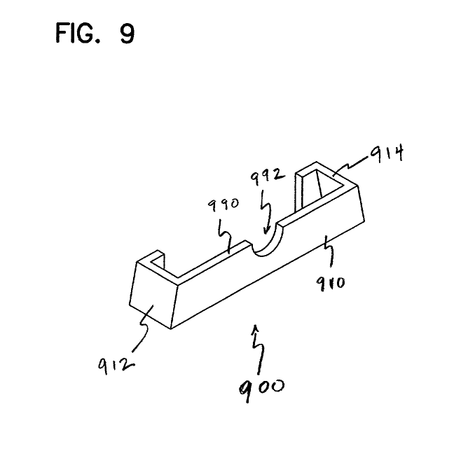

Referring to FIG. 9, a front top schematic perspective view of a fifth embodiment of a hanging device 900 is shown. The hanging device 900 has a hanging bar 910 and engaging brackets 912 and 914. The hanging bar 910 includes an upper edge 990 that defines a notch 992. Notch 992 can be used to hold and engage items such as, for example, paint bucket handles, in a stationary position on the hanging bar 910.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A method for hanging an item, comprising:
placing a removable item onto a hanging device, wherein the hanging device comprises a hanging bar and engaging brackets; and
placing the hanging device onto side rails of a stepladder, wherein the engaging brackets couple the hanging device to the side rails.

2. A hanging device for support structures, comprising:
a hanging bar to removably engage at least one item; and
engaging brackets coupled to the hanging bar, wherein the engaging brackets couple the hanging device to an angled support structure.

3. The hanging device of claim 2, wherein the angled support structure comprises side rails of a stepladder when the stepladder is in an open position.

4. The hanging device of claim 2, wherein the at least one item is a tool belt.

5. The hanging device of claim 2, wherein an upper edge of the hanging bar defines a notch.

6. A hanging device for support structures, comprising:
a hanging bar to removably engage one item, wherein the hanging bar comprises a first portion adjustably coupled to a second portion; and
engaging brackets coupled to the hanging bar, wherein the engaging brackets couple the hanging device to an angled support structure.

7. The hanging device of claim 6, wherein the angled support structure comprises side rails of a stepladder when the stepladder is in an open position.

8. The hanging device of claim 6, wherein the at least one item is a tool belt.

9. A supporting device, comprising:
a hanging bar;
engaging brackets coupled to the hanging bar; and
a support structure, wherein the engaging brackets are coupled to an angled support structure and at least one item is removably suspended from the hanging bar.

10. The supporting device of claim 9, wherein the angled support structure comprises side rails of a stepladder, and the engaging brackets are coupled to the side rails.

11. A supporting device comprising:
a support structure comprising a support bar coupled to a support rod, wherein the support bar comprises angled sidebars; and
a hanging device coupled to the angled sidebars.

12. The supporting device of claim 11, further comprising at least one item removably coupled to the hanging device.
